(19) United States
(12) Patent Application Publication
(10) Pub. No.: US 2026/0311476 A1
(43) Pub. Date: Oct. 8, 2026

(54) TRAINING VISION LANGUAGE NEURAL NETWORKS WITH COMPONENT REUSE

(71) Applicant: Google LLC, Mountain View, CA (US)

(72) Inventors: Jiahui Yu, Bellevue, WA (US); Siyuan Qiao, Cupertino, CA (US); Zhishuai Zhang, Baltimore, MD (US); Xu Chen, Redwood City, CA (US); Yonghui Wu, Fremont, CA (US)

(21) Appl. No.: 19/481,560

(22) PCT Filed: May 10, 2024
(86) PCT No.: PCT/US2024/028819

§ 371 Date: Nov. 5, 2025

Related U.S. Application Data
(60) Provisional application No. 63/465,478, filed on May 10, 2023.

(51) Int. Cl. G06V 10/82; G06F 40/284; G06N 3/0455

(52) U.S. Cl. CPC G06V 10/82; G06F 40/284; G06N 3/0455

(57) ABSTRACT

Methods, systems, and apparatus, including computer programs encoded on computer storage media, for generating and training a glued neural network that reuses components taken from a first pre-trained neural network and a second pre-trained neural network. For example, the first pre-trained neural network can be a multi-modal neural network that includes a visual encoder neural network and a small-scale language model neural network. The second pre-trained neural network can be a large-scale language model neural network.

### CROSS-REFERENCE TO RELATED APPLICATION

This application claims priority to U.S. Provisional Application No. 63/465,476, filed on May 10, 2023. The disclosure of the prior application is considered part of and is incorporated by reference in the disclosure of this application.

### BACKGROUND

This specification relates to processing data using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that trains a glued neural network that reuses components taken from a first pre-trained neural network and a second pre-trained neural network.

For example, the first pre-trained neural network can be a multi-modal neural network that includes a visual encoder neural network and a small-scale language model neural network. The second pre-trained neural network can be a large-scale language model neural network. The system can generate a glued neural network that includes components taken from both the visual encoder neural network and the large-scale language model neural network, and then train the glued neural network using a plurality of training pairs that each include a visual input and a text sequence.

The subject matter described in this specification can be implemented in particular embodiments so as to realize one or more of the following advantages.

The described techniques can generate and train a multi-modal neural network that reuses components, including the architectures and corresponding parameter values, of two different large-scale neural networks that have been separately pre-trained on different upstream tasks. A large-scale neural network is a neural network with many parameters, e.g., 1 billion parameters, 10 billion parameters, 100 billion parameters, or 500 billion or more parameters. For example, the multi-modal neural network can be configured to process multi-modal inputs that include both a visual input, i.e., an image or multiple video frames from a video, and a text input to generate an output, which depends both on the visual input and on the text input.

By reusing the components of the already pre-trained large scale neural networks, the multi-modal neural network can leverage the knowledge gained by the pre-trained neural networks from different tasks and different data modalities to allow the training of the multi-modal neural network on a midstream task to be limited to adjusting only a limited number of model parameters. Therefore the midstream training can be very computing resource-efficient.

Moreover, as a result of the midstream training, the multi-modal neural network can be more easily adapted, e.g., through one-shot learning, few-shot learning, or fine-tuning, to any of a range of downstream multi-modal tasks. Once adapted, the multi-modal neural network incorporating large-scale pre-trained neural networks as its constituent components can achieve or even exceed the performance of a conventionally pre-trained neural network on any of the downstream multi-modal tasks, despite an adaptation process that consumes fewer computing resources, is faster in terms of wall-clock time, or both.

In general, performance of the previously mentioned multi-modal processing tasks can be enhanced when the visual input or the text input is processed by a large-scale neural network that has greater model capacity due to its increased model size. In some examples, accuracy of detection or classification of objects or events and, similarly, objective or perceptual quality of generated data items (e.g., new text, new images, or new audio signals) can be improved when data of multiple different modalities is processed by one or more larger-scale neural networks, rather than one or more smaller-scale neural networks that are typically included in a conventional multi-modal neural network.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example glued neural network.

FIG. 1B shows an example training system.

FIG. 2 is an example illustration of an upstream pre-training stage, a midstream training stage, and a downstream adaptation stage.

FIG. 3 is a flow diagram of an example process for training a glued neural network.

FIG. 4 is a flow diagram of sub-steps of one of the steps of the process of FIG. 3.

Like reference numbers and designations in the various drawings indicate like elements.

### DETAILED DESCRIPTION

This specification describes a system implemented as computer programs on one or more computers in one or more locations that trains a glued neural network that reuses components taken from a first pre-trained neural network and a second pre-trained neural network.

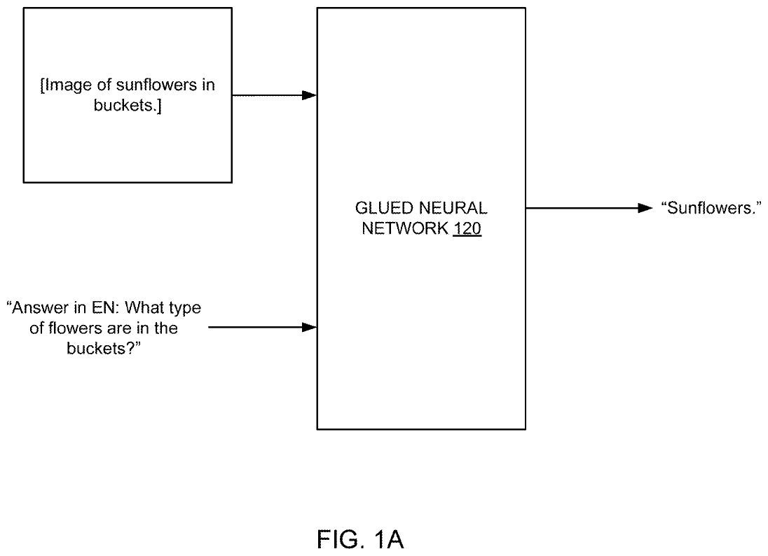

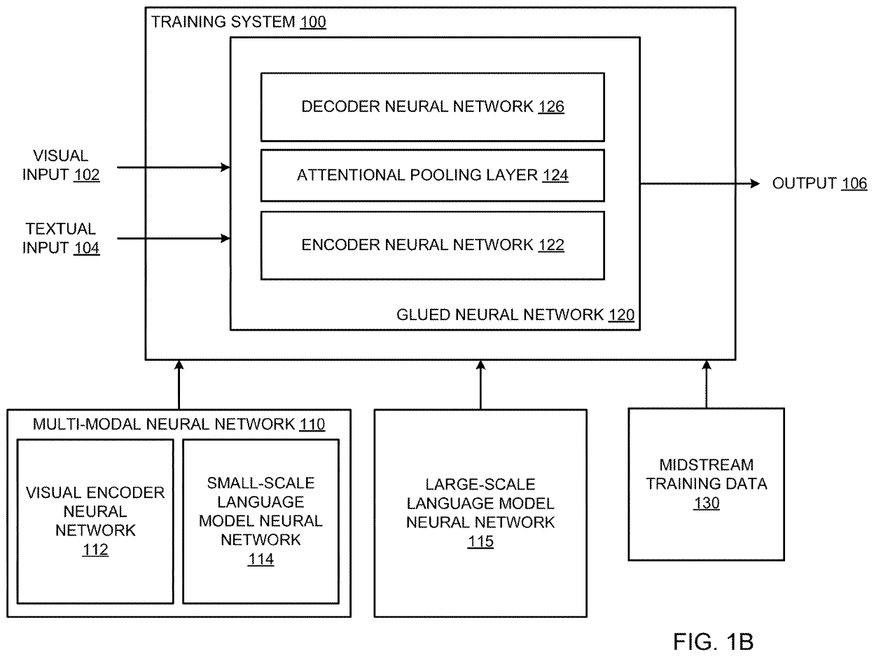

FIG. 1A shows an example glued neural network 120. The glued neural network 120 is configured as a multi-modal neural network that can perform a multi-modal machine learning task. A multi-modal machine learning task is a task that requires the neural network to process multi-modal data, i.e., to process inputs that include data from two or more modalities, in order to generate the outputs for the task.

In particular, the glued neural network 120 includes components taken from a first pre-trained neural network and a second pre-trained neural network. The first pre-trained neural network and the second pre-trained neural network can have been trained separately on different upstream tasks, which may be, but need not be multi-modal tasks. A large-scale neural network is a neural network with many parameters, e.g., 1 billion parameters, 10 billion parameters, 100 billion parameters, or 500 billion or more parameters.

In general, multi-modal data is a combination of two or more different types of data, e.g., two or more of audio data, image data, textual data, or graph data. As one example the multi-modal data may comprise audio-visual data, comprising a combination of pixels of an image or of video and audio data representing values of a digitized audio waveform. As another example the multi-modal data may comprise a combination of i) text data representing text in a natural language and ii) pixels of an image or of video or audio data representing values of an audio waveform. Optionally, but not necessarily, the different types of data may represent the same or overlapping objects using the different modalities (types), and when processing multi-modal data the data may be mapped into a common embedding space.

In some cases, the task is a multi-modal understanding task. For example, the task can be a visual question answering task that requires generating an answer to a question that is posed about a visual input. FIG. 1A thus illustrates that the glued neural network 120 processes an image that includes a depiction of sunflowers in buckets, and a text input that specifies a question “What type of flowers are in the buckets?” and to generate a text output that is an answer to the question “Sunflowers.”

As another example, the task can be an open-vocabulary image classification task, where the neural network is configured to receive an input tuple including an image and a natural language sequence for the image, which may be a sequence of words in a target natural language that describes the image, and to process the network input to generate a classification output that specifies whether the natural language sequence includes an accurate description for the image. As another example, the task can be an open-vocabulary object detection task, where the neural network is configured to receive an input tuple including an image and text describing a set of object categories, and to process the network input to generate a network output that includes a respective score for each of the set of object categories representing an estimated likelihood that the image contains an image of an object belonging to the category. As another example, the task can be a cross-modal retrieval task that requires (i) retrieving one or more most similar text sequences to a visual input or (ii) retrieving one or more most similar visual inputs to a text sequence. Further examples of the multi-modal understanding task include an image captioning task that requires generating a text caption for a visual input, a text-based image search task that requires identifying images based on a text description of the target content of an image, and so on.

In some cases, the task can be an agent control task, where the input includes observations characterizing an environment and natural language instructions characterizing a task to be performed by the agent, and the output defines an action to be performed by the agent in response to the most recent observation.

The agent can be, e.g., a real-world or simulated robot, a control system for an industrial facility, or a control system that controls a different kind of agent. The observations may comprise sensor data captured by sensors associated with (e.g. part of) the agent, for example visual data, LIDAR data, sonar data, agent configuration data (e.g. joint angles), agent orientation data, or the like.

The natural language instructions can be received from another agent in the environment or from a control system of the agent. For example, another agent in the environment can speak an instruction and the robot or another system can transcribe it into natural language text. As another example, the control system can receive a text input from a user representing the natural language instruction.

In some implementations, the environment is a real-world environment, the agent is a mechanical (or electro-mechanical) agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example captured by a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example, a system implementing the neural network may be used to select actions in the simulated environment during training or evaluation of the system and, after training, or evaluation, or both, are complete, the action selection policy may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

In some implementations, as described above, the agent may not include a human being (e.g. it is a robot). Conversely, in some implementations the agent comprises a human user of a digital assistant such as a smart speaker, smart display, or other device. Then the information defining the task can be obtained from the digital assistant, and the digital assistant can be used to instruct the user based on the task.

In some cases, the task can be a health-related task to make predictions about the health of a patient from multi-modal data relating to the patient, e.g., to predict the likelihood of one or more health events occurring to the patient in some future time period, to predict a treatment that should be prescribed to the patient, or to predict a diagnosis for the patient.

The multiple modalities can include multiple different feature modalities from the electronic health record of the patient. In particular, the multiple different feature modalities can include two or more of: (1) contextual features, such as patient age and sex; (2) longitudinal categorical features, such as procedure codes, medication codes, and condition codes; (3) longitudinal continuous features, such as blood pressure, body temperature, and heart rate; and (4) longitudinal free-text clinical notes, which are often lengthy and contain a lot of medical terminology.

These data types differ not only in feature spaces and dimensionalities, but also in data generation processes and measurement frequencies. For example, lab tests and procedures are ordered at the physician's discretion and therefore occur at irregular frequencies in the electronic health record, while blood pressure and body temperature can be monitored on a regular basis.

Instead of or in addition to one or more modalities from the electronic health record, the multiple modalities can also include any of: medical imaging data for the patient, genomics data for the patient, or speech waveform or other audio waveform data that is relevant to the patient.

In some cases, the task is a task that requires processing audio data of a person speaking and corresponding video. That is, one modality is audio data and the other data is the corresponding video data. Examples of such tasks include audio-visual speech recognition and visual question-answering.

In some cases, the task is a content recommendation task that requires processing data from multiple feature modalities to make a recommendation of one or more content items to be presented to a user. The feature modalities can include two or more of: content data characterizing the content item currently being presented to the user, meta data for the content data, or history data characterizing previous content items that have been previously presented to the user and, optionally, data characterizing the interaction of the user with the previously presented content items.

FIG. 1B shows an example training system 100. The training system 100 is an example of a system implemented as computer programs on one or more computers in one or more locations, in which the systems, components, and techniques described below can be implemented.

The training system 100 can train the glued neural network 120 to perform any one or more of the multi-modal machine learning tasks mentioned above, i.e., to process a visual input 102 that includes image data and a textual input 104 that includes text data to generate an output 106 for the task. The output 106 can be, for example, a generative output, a classification output, a regression output, or the like.

The glued neural network 120 includes (i) an encoder neural network 122 that is configured to process a visual input 102 that includes one or more images to generate an encoded representation of the visual input, (ii) an attentional pooling layer 124 that is configured to process the encoded representation of the visual input to generate an updated encoded representation of the visual input, and (iii) a decoder neural network 126 that is configured to process (a) the updated encoded representation of the visual input and (b) data derived from the textual input 104 to generate an output 106.

As used herein, the term “image” can refer to any image data or digital data that defines an image that can be represented, e.g., as an array of pixels. Images may, for example, be two dimensional, three dimensional, or in the form of a video. Images may be captured by a scanner, a camera, a specially-adapted sensor array (such as CMOS array), a microscope, a smartphone camera, a video camera, an x-ray machine, a sonar, an ultrasound machine, a microphone (or other instruments for converting sound waves into electrical energy variations), etc.

Before the training of the glued neural network 120 has begun, the training system 100 obtains initialization data for use in initializing the architecture and the parameter values of the glued neural network 120.

The initialization data can be obtained in any of a variety of possible ways. For example, the training system 100 can receive the initialization data as an upload from a remote user of the system over a data communication network, e.g., using an interface made available by the system. The interface can be a command-line interface (CLI), a graphical user interface (GUI), an application programming interface (API), or various combinations of the three and possibly another user interface (e.g., a web browser as user interface). As another example, the system can receive an input from a user specifying which data that is already maintained by the system, or another system that is accessible by the system should be used as the initialization data.

The initialization data includes data that defines an architecture of a multi-modal neural network 110 and that defines the trained values of the parameters of the multi-modal neural network 110 that have been determined as a result of the training of the multi-modal neural network 110 that has already occurred.

The multi-modal neural network 110, in turn, includes a visual encoder neural network 112 and a small-scale language model neural network 114. The visual encoder neural network 112 has been trained jointly with the small-scale language model neural network 114 as part of the multi-modal neural network 110 to perform one or more upstream multi-modal tasks.

The visual encoder neural network 112 has been configured through training to process a visual input that includes one or more images to generate an encoded representation of the visual input. The small-scale language model neural network 114 has been configured through training to process a textual input that includes one or more text sequences, and, in some implementations, the encoded representation of the visual input to generate an encoded representation of the textual input, or an encoded multi-modal representation of both the textual input and the visual input. For example, the small-scale language model neural network 114 can include one or more self-attention layers that operate on the textual input to generate an encoded representation of the textual input, and one or more cross-attention layers that operate on both the encoded representation of the textual input and the encoded representation of the visual input to generate the encoded multi-modal representation.

By processing the encoded representation of the textual input and, in some implementations, the encoded representation of the visual input using one or more output layers, the multi-modal neural network 110 can generate an output for an upstream multi-modal task.

In some particular examples, the visual encoder neural network 112, the small-scale language model neural network 114, and the one or more upstream multi-modal tasks can be one of the visual encoder neural networks, one of the language model neural networks, and one or more of the multi-modal tasks, respectively, mentioned in Yu, Jiahui, et al. “Coca: Contrastive captioners are image-text foundation models.” arXiv preprint ar Xiv:2205.01917 (2022), or Chen, Xi, et al. “Pali: A jointly-scaled multilingual language-image model.” arXiv preprint arXiv:2209.06794 (2022).

In the CoCa example, the visual encoder neural network 112 and the small-scale language model neural network 114 have been jointly trained to minimize both a contrastive learning loss and a captioning loss using a set of upstream training pairs that each include a respective visual input and a respective text sequence, where the visual input and the input text sequence are semantically similar to each other.

Additionally, the initialization data includes data that defines an architecture of a large-scale language model neural network 115 and that defines the trained values of the parameters of the large-scale language model neural network 115 that have been determined as a result of the training of the large-scale language model neural network 115 that has already occurred.

The large-scale language model neural network 115 has been trained to perform one or more upstream language modeling tasks, i.e., to process a textual input to generate a textual output for a language modeling task. In other words, unlike the multi-modal neural network 110 which operates on data from two or more modalities, the large-scale language model neural network 115 operates on data from just one modality, i.e., textual data.

For example, the upstream language modeling task can include a natural language processing or understanding task, e.g., an entailment task, a paraphrase task, a textual similarity task, a sentiment task, a sentence completion task, a grammaticality task, and so on, that operates on a sequence of text in some natural language.

As another example, the upstream language modeling task can include a text generation task, where the input is a sequence of text, and the output is another sequence of text, e.g., a completion of the input sequence of text, a response to a question posed in the input sequence, or a sequence of text that is about a topic specified by the first sequence of text.

As another example, the upstream language modeling task can include a neural machine translation task. For example, if the input to the neural network is a sequence of text, e.g., a sequence of words, phrases, characters, or word pieces, in one language, the output generated by the neural network may be a translation of the sequence of text into another language, i.e., a sequence of text in the other language that is a translation of the input sequence of text.

In some cases, the large-scale language model neural network 115 can be configured through training to receive an input sequence made up of tokens selected from a vocabulary and generate an output sequence made up of tokens from the vocabulary.

In some cases, the training of the large-scale language model neural network 115 can include an unsupervised pre-training stage, during which the large-scale language model neural network 115 is trained on large amounts of unlabeled data based on optimizing an unsupervised or self-supervised training objective, optionally followed by one or more fine-tuning stages, e.g., supervised fine-tuning (SFT), reinforcement learning from human feedback (RLHF), instruction tuning, and the like, that use different training objectives, different data, or both.

The vocabulary of tokens can include text tokens that can represent textual data. For example, the vocabulary of tokens can include any of: characters, subwords, words, punctuation marks, sign tokens (e.g., the #, $, and other signs), mathematical symbols, and so on in a language, e.g., a natural language, a computer programming language, or a markup language.

Additionally, or alternatively, the vocabulary of tokens can include tokens that can represent data other than text. For example, the vocabulary of tokens can include image tokens that represent a discrete set of image embeddings that can be generated by an image encoder neural network based on processing the image. As another example, the vocabulary of tokens can include audio tokens that represent code vectors in a codebook of a quantizer, e.g., a residual vector quantizer.

In some particular examples, the large-scale language model neural network 115 and the one or more upstream language modeling tasks can be one of the language model neural networks and one or more of the language modeling tasks, respectively, mentioned in Tay, Yi, et al. “Ul2: Unifying language learning paradigms.” arXiv preprint arXiv:2205.05131 (2022), and Anil, Rohan, et al. “Palm 2 technical report.” arXiv preprint arXiv:2305.10403 (2023).

The small-scale language model neural network 114 is referred to as “small-scale” because it has a relatively small number of parameters. In contrast, the large-scale language model neural network 115 is referred to as “large-scale” because it has a relatively large number of parameters, and in particular has more parameters than the small-scale language model neural network 114.

In some cases, the number of parameters of the large-scale language model neural network 115 is an order of magnitude greater than the number of parameters of the small-scale language model neural network 114. For example, the small-scale language model neural network 114 can include about 1 billion parameters, about 13 billion parameters, and so forth, whereas the large-scale language model neural network 115 can include about 70 billion parameters, about 340 billion parameters, and so forth.

Having obtained the initialization data, the training system 100 then generates the glued neural network 120 based on the multi-modal neural network 110 and the large-scale language model neural network 115.

In particular, the glued neural network 120 includes architectures and parameters taken from both the visual encoder neural network 112 and the large-scale language model neural network 115. Some implementations of the training system 100 can generate the glued neural network 120 by using (at least a portion of) the multi-modal neural network 110 as a baseline architecture of the glued neural network 120 but replacing the small-scale language model neural network 114 included in the multi-modal neural network 110 with (at least a portion of) the large-scale language model neural network 115. In some implementations, an attentional pooling layer is included in the visual encoder neural network 112 as one of the set of layers of the visual encoder neural network 112. In these implementations, the training system 100 can generate the glued neural network 120 by reusing the attentional pooling layer as the attentional pooling layer 124 in the architecture of the glued neural network 120.

FIG. 1B illustrates that the glued neural network 120 includes an encoder neural network 122, followed by an attentional pooling layer 124, followed by a decoder neural network 126.

The encoder neural network 122 processes the visual input 102 that includes one or more images to generate the encoded representation of the visual input.

The encoder neural network 122 is generated by the training system 100 based on the visual encoder neural network 112. In some implementations, the encoder neural network 122 has an identical architecture and identical parameter values with (at least a portion of) the visual encoder neural network 122.

For example, the visual encoder neural network 112 includes a given set of neural network layers arranged in a given order, and the encoder neural network 122 includes the same given set of neural network layers arranged in the same given order. For example, the first layer of the encoder neural network 122 that receives the input to the encoder neural network 122 has the same configuration and, in implementations where the first layer has a set of parameters, the same parameter values as the first layer of the visual encoder neural network 112 that receives the input to the visual encoder neural network 112.

As another example, the visual encoder neural network 112 includes a given set of neural network layers arranged in a given order, and the encoder neural network 122 includes a subset of the given set of neural network layers arranged in the same given order in which the subset of the given set of neural network layers are arranged in the visual encoder neural network 112. For example, the visual encoder neural network 112 can include one or more different layers in place of some of the layers included in the encoder neural network 122.

In either example, the parameters of the same layers included in the visual encoder neural network 112 and the encoder neural network 122 have the same values, i.e., the trained values that are determined as a result of the training of the multi-modal neural network 110 that has already occurred.

In some particular examples, the visual encoder neural network 112 includes particular types of neural network layers (e.g., convolutional layers, attention layers, etc.) in particular numbers (e.g., 5, 10, or 100 layers) and arranged in a particular configuration (e.g., as a linear sequence of layers, either with or without residual connections), and the encoder neural network 122 includes the same particular types of neural network layers in the same particular numbers and arranged in the same particular configuration. For example, the visual encoder neural network 112 and the encoder neural network 122 can both have a vision Transformer (ViT) architecture that includes a plurality of attention blocks, both have a ResNet architecture includes a plurality of convolution blocks, and so on.

The glued neural network 120 then provides the encoded representation of the visual input, i.e., the output of the last layer of the encoder neural network 122, as input to the attentional pooling layer 124.

The attentional pooling layer 124 processes the encoded representation of the visual input by applying an attention mechanism over the embeddings in the encoded representation and a set of learned query tokens to update the encoded representation, i.e., to generate an updated encoded representation of the visual input. That is, the attentional pooling layer 124 uses the learned query tokens to generate queries for the attention mechanism applied by the attentional pooling layer 124 and the embeddings in the encoded representation to generate keys and values for the attention mechanism. The output of the attentional pooling layer is therefore an updated query token for each of the set of query tokens.

The attentional pooling layer 124 applies the attention mechanism in accordance with parameters of the attentional pooling layer 124. For example, the attentional pooling layer 124 uses different subsets of the parameters of the attentional pooling layer 124 generate the set of query tokens, and to process the encoded representation to generate the keys and values for the attention mechanism applied by the attentional pooling layer 124.

In some implementations, like the encoder neural network 122, the attentional pooling layer 124 is generated by the training system 100 based on the visual encoder neural network 112. For example, the visual encoder neural network 112 includes the attentional pooling layer 124 as one of the set of layers of the visual encoder neural network 112. In these implementations, the parameters of the attentional pooling layer 124 have been learned jointly with the parameters of the other layers of the visual encoder neural network 112 and the parameters of the layers of the small-scale language model neural network 114 as a result of the training of the multi-modal neural network 110 that has already occurred.

The glued neural network 120 then provides updated encoded representation of the visual input as input to the decoder neural network 126, i.e., to the first layer of the decoder neural network 126. The decoder neural network 126 is generated by the training system 100 based on the large-scale language model neural network 115, as will be explained further below.

The decoder neural network 126 receives and process the updated encoded representation of the visual input and text embeddings of the textual input 104 to generate the output 106. In implementations the decoder neural network 126 can receive the updated encoded representation of the visual input and text embeddings of the textual input 104 in any of variety of ways, e.g., (i) receive, as input to an input layer of the decoder neural network 126, both the updated encoded representation of the visual input and text embeddings of the textual input 104, (ii) use cross-attention layers to cross-attend to the updated encoded representation of the visual input and text embeddings of the textual input 104, or (iii) both.

The glued neural network 120 can represent the textual input 104 that includes a sequence of text as text embedding in any appropriate way. An embedding refers to an ordered collection of numerical values, e.g., a vector, matrix, or other tensor of numerical values. For example, the glued neural network 120 can represent the sequence of text as a sequence of tokens from a vocabulary of tokens, and then map each token to a corresponding numerical value in accordance with a predetermined mapping. The vocabulary of tokens can include any of the text tokens, image tokens, or audio tokens mentioned above.

In implementations the decoder neural network 126 can stochastically generate the output 106. For example, the decoder neural network 126 can include an output layer that generates an output that specifies a probability distribution over the vocabulary of tokens, i.e., that includes a respective probability score for each respective token included in the vocabulary. The glued neural network 120 can then select a token from the set of vocabulary of tokens using the probability distribution.

Furthermore, when the output 106 is an output sequence that includes a respective output at each of multiple positions in the output sequence, then the glued neural network 120 can generate the output 106 in an auto-regressive manner by, for each position within the output sequence, generating the probability distribution over the vocabulary of tokens conditioned on any tokens at preceding positions within the output sequence that have already been generated by the glued neural network 120.

As mentioned above, the tokens can include one or more of: text tokens that can represent textual data, image tokens that represent image embeddings, audio tokens that represent code vectors. Thus the decoder neural network 126 can generate outputs 106 in any data modalities including text data, image data, or audio data.

In the example where the output 106 include image data, an image decoder neural network (that has been trained jointly with the image encoder neural network that can generate the image embeddings) can process the image embeddings represented by the image tokens generated by the glued neural network 120 to generate an image by mapping the image embeddings to pixel space.

Analogously, in the example where the output 106 include audio data, an audio decoder neural network can process the code vectors represented by the audio tokens generated by the glued neural network 120 to generate an audio signal. The audio signal can be an audio example that includes a sample of an audio wave at each of a sequence of output time steps that span a specified time window. For example, the output time steps can be arranged at regular intervals within the specified time window. The audio sample at a given time step can be an amplitude value of the audio wave or an amplitude value that has been compressed, companded, or both. For example, the audio sample can be a raw amplitude value or a mu-law companded representation of the amplitude value.

The decoder neural network 126 is generated by the training system 100 based on the large-scale language model neural network 115. In some implementations, the decoder neural network 126 has an identical architecture and identical parameter values with (at least a portion of) the large-scale language model neural network 115.

In some implementations, one or more initial layers of the large-scale language model neural network 115 that receive the textual inputs for the upstream language modeling tasks are not reused by the training system 100 when generating the decoder neural network 126. Instead, the training system 100 uses, in place of the one or more initial layers of the large-scale language model neural network, one or more alternative layers that have different configurations and that are capable of receiving the updated encoded representation of the visual input and text embeddings of the textual input 104.

In some other implementations, when generating the decoder neural network 126, the training system 100 reuses the one or more initial layers of the large-scale language model neural network 115 in the decoder neural network 126, and additionally inserts one or more extra layers that have different configurations and that are capable of receiving the updated encoded representation of the visual input.

For example, the large-scale language model neural network 115 includes a given set of neural network layers arranged in a given order, and the decoder neural network 126 includes the same given set of neural network layers arranged in the same given order. For example, the first layer of the decoder neural network 126 that receives the updated encoded representation of the visual input generated by the attentional pooling layer 124 has the same configuration and, in implementations where the first layer has a set of parameters, the same parameter values as the first layer of the large-scale language model neural network 115 that receives the input of the large-scale language model neural network 115.

As another example, the large-scale language model neural network 115 includes a given set of neural network layers arranged in a given order, and the decoder neural network 126 includes a subset of the given set of neural network layers arranged in the same given order in which the subset of the given set of neural network layers are arranged in the large-scale language model neural network 115. For example, the decoder neural network 126 can include one or more different layers in place of some of the layers included in the large-scale language model neural network 115.

In either example, the parameters of the same layers included in the large-scale language model neural network 115 and the decoder neural network 126 have the same values, i.e., the trained values that are determined as a result of the training of the large-scale language model neural network 115 that has already occurred.

In some particular examples, the large-scale language model neural network 115 includes particular types of neural network layers (e.g., attention layers, feed-forward layers, softmax layers, etc.) in particular numbers (e.g., 5, 10, or 100 layers) and arranged in a particular configuration (e.g., as a linear sequence of layers, either with or without residual connections), and the decoder neural network 126 includes the same particular types of neural network layers in the same particular numbers and arranged in the same particular configuration.

Having generated the glued neural network 120 based on the initialization data, the training system 100 trains the glued neural network 120 on midstream training data 130 based on optimizing a loss function for a midstream multi-modal task.

The midstream training data 130 includes a plurality of midstream training pairs. Each midstream training pair includes (i) a visual input that includes an image (e.g., that includes an image) and (ii) a text sequence (e.g., that is a semantically similar to the image include in the visual input).

Optionally, each of at least some of the midstream training pairs is a concatenated midstream training pair that is a concatenation of multiple midstream training pairs. A concatenated midstream training pair includes multiple visual inputs and multiple text sequences that are interleaved within each other.

For example, a concatenated midstream training pair can include a first visual input (e.g., that includes a first image), followed by a first text sequence that corresponds to the first visual input (e.g., that is a semantically similar to the first image), followed by a second visual input (e.g., that includes a second image), followed by a second text sequence that corresponds to the second visual input (e.g., that is a semantically similar to the second image), and so on in that order.

The midstream multi-modal task can be any multi-modal task that requires the glued neural network 120 to process both image data and visual data in order to generate the outputs for the task, and the loss function can be any loss function that is appropriate for the midstream multi-modal task.

In some implementations, the midstream multi-modal task is the task that is specified by the midstream training data 130 or the provider of the midstream training data 130.

In some implementations, the training system 100 selects, from among a predetermined set of multi-modal tasks, a multi-modal task as the midstream multi-modal task on which the glued neural network 120 will be trained. Such a selection is typically made to facilitate the downstream adaptation of the glued neural network 120 for a downstream multi-modal task, e.g., to reduce the computing resources, the wall-clock time, or both that are required to perform the downstream adaptation (after the glued neural network 120 has been trained on the midstream multi-modal task).

For example, when the downstream multi-modal task is an image captioning task or a visual question answering task, then the training system 100 can use an image-to-text generation task as the midstream multi-modal task. By training the glued neural network 120 on such an image-to-text generation task, the training system 100 can enhance the conditional text generation capabilities of the glued neural network 120 that will improve its performance on the image captioning task or the visual question answering task (or another downstream task that requires the glued neural network 120 to generate outputs that include text data).

In this example, the loss function for the midstream multi-modal task can be a self-supervised loss function that includes one or more terms that measure, for each midstream training pair, a difference between (i) a predicted text sequence that is generated by the glued neural network 120 based on processing the visual input included in the midstream training pair and (ii) the text sequence, the visual input, or both included in the midstream training pair.

As another example, when the downstream multi-modal task is a cross-modal retrieval task (that requires retrieving one or more most similar visual inputs to a text sequence), then the training system 100 can use a text-to-image generation task as the midstream multi-modal task. By training the glued neural network 120 on such a text-to-image generation task, the training system 100 can enhance the conditional image generation capabilities of the glued neural network 120 that will improve its performance on the cross-modal retrieval task (or another downstream task that requires the glued neural network 120 to generate outputs that include image data).

In this example, the loss function for the midstream multi-modal task can be a self-supervised loss function that includes one or more terms that measure, for each midstream training pair, a difference between (i) a predicted visual output, e.g., an image, that is generated by the glued neural network 120 based on processing the text sequence included in the midstream training pair and (ii) the visual input, the text sequence, or both included in the midstream training pair.

More specifically, the training system 100 performs the training over a plurality of training iterations. At each training iteration, the training system 100 updates some of the parameters of the glued neural network 120 using a plurality of midstream training pairs (a “batch” or a “mini-batch” of midstream training pairs) sampled from the midstream training data 130.

Thus, by repeatedly performing the training iterations, the training system 100 repeatedly updates the values of some of the parameters of the glued neural network 120 to determine trained values of the parameters of the glued neural network 120 that will cause the glued neural network 120 to perform well on the midstream multi-modal task.

More specifically, at each training iteration, the training system 100 computes, using the plurality of midstream training pairs, a gradient of the loss function for the midstream multi-modal task with respect to each of some of the parameters of the glued neural network 120, and then applies an optimizer to the gradients to adjust, i.e., update, those parameters of the glued neural network 120.

In particular, at each of the plurality of training iterations, the training system 100 adjusts only a proper subset of all of the parameters of the glued neural network 120 while holding other parameters of the glued neural network 120 that are not in the proper subset fixed.

In some implementations, the proper subset of the parameters of the glued neural network 120 include parameters of the attentional pooling layer 124. That is, the training system 100 adjusts the parameters of the attentional pooling layer 124 while holding the parameters of the other components of the glued neural network 120, i.e., parameters of the layers of the encoder neural network 122 and the decoder neural network 126, fixed.

In implementations where the attentional pooling layer 124 is included as one of the set of layers of the visual encoder neural network 112 that is defined by the initialization data, prior to any of the training iterations, i.e., before training has begun, the training system 100 sets the initial values of the parameters of the attentional pooling layer 124 included in the glued neural network 120 to be the same as the trained values of the parameters of the attentional pooling layer that have been determined as a result of the training of the multi-modal neural network 110 that has already occurred, and then continues to adjust the parameters of the attentional pooling layer 124 included in the glued neural network 120 over the plurality of training iterations beginning from their initial values.

In some implementations, the proper subset of the parameters of the glued neural network 120 additionally include: parameters of one or more attention layers, parameters of one or more feed-forward layers, or some combination of these and possibly other layers of the decoder neural network 126. That is, the training system 100 adjusts the parameters of the attentional pooling layer 124 and parameters of the layers of the decoder neural network 126 while holding the parameters of the other layers of the glued neural network 120, e.g., parameters of the layers of the encoder neural network 122, fixed.

In these implementations, prior to any of the training iterations, i.e., before training has begun, the training system 100 sets the initial values of the parameters of the layers of the decoder neural network 126 included in the glued neural network 120 to be the same as the trained values of the parameters of the layers of the large-scale language model neural network 115 that have been determined as a result of the training of the large-scale language model neural network 115 that has already occurred, and then continues to adjust the parameters of the layers of the decoder neural network 126 included in the glued neural network 120 over the plurality of training iterations beginning from their initial values.

After having trained the glued neural network 120 to perform the midstream multi-modal task, the training system 100 can then perform zero-shot, few-shot, or finetuning downstream adaptation in order to use at least part of the glued neural network 120 for a downstream multi-modal task.

That is, in some implementations, the glued neural network 120 can be adapted to the downstream multi-modal task in a zero-shot or a few-shot manner, i.e., without further training of any of the components of the glued neural network 120 or any additional components. In the case of few-shot adaptation, the glued neural network 120 will process a small number of concrete examples of inputs and outputs for the downstream task (but its parameters remain unadjusted).

In some other implementations, the downstream task can be performed after fine-tuning one or more of the components of the glued neural network 120 on labeled training data for the downstream task, e.g., using a different optimizer or on a different loss function, e.g., a supervised learning loss function. For example, for fine-tuning adaptation, the training system 100 can fine-tune the encoder neural network 122, the attentional pooling layer 124, the decoder neural network 126, or any other parts of the glued neural network 120 that are used for the downstream task.

In general, the downstream multi-modal task can be any one of the multi-modal machine learning tasks mentioned above with reference to FIG. 1B.

In some implementations, the downstream multi-modal task is different from any of the upstream or midstream multi-modal tasks. For example, the downstream multi-modal tasks can be an image captioning task or a visual question answering task, while the midstream multi-modal task is an image-to-text generation task, and the upstream multi-modal tasks include other tasks, e.g., an open-vocabulary image classification task or an open-vocabulary object detection task.

As another example, the downstream multi-modal tasks can be a cross-modal retrieval task (that requires retrieving one or more most similar visual inputs to a text sequence), while the midstream multi-modal task is a text-to-image generation task, and the upstream multi-modal tasks include other tasks, e.g., an open-vocabulary image classification task or an open-vocabulary object detection task.

The examples in this specification generally discuss training a multi-modal neural network that processes image and text data, i.e., that is configured as a visual language model (VLM) neural network. However, the same techniques that trains a glued neural network that reuses components taken from both a first pre-trained neural network that has been pre-trained on one or more upstream multi-modal tasks and a second pre-trained neural network that has been pre-trained on one or more upstream single-modal tasks can also be applied to any other neural networks for processing data from any other modalities, e.g., inputs that include audio data, inputs that include graph data, inputs that include genomics data, and so on.

Merely as an example, the first pre-trained neural network can be a multi-modal neural network that includes an audio encoder neural network and a small-scale video processing neural network that has been pre-trained on one or more upstream audio-visual tasks. The second pre-trained neural network can be a large-scale video processing neural network has been pre-trained on one or more upstream video processing tasks. The training system 100 can generate a glued neural network that includes components taken from both the audio encoder neural network and the large-scale video neural network, and then train the glued neural network using a plurality of midstream training pairs that each include an audio input and a video input, e.g., each include audio data of a person speaking and corresponding video.

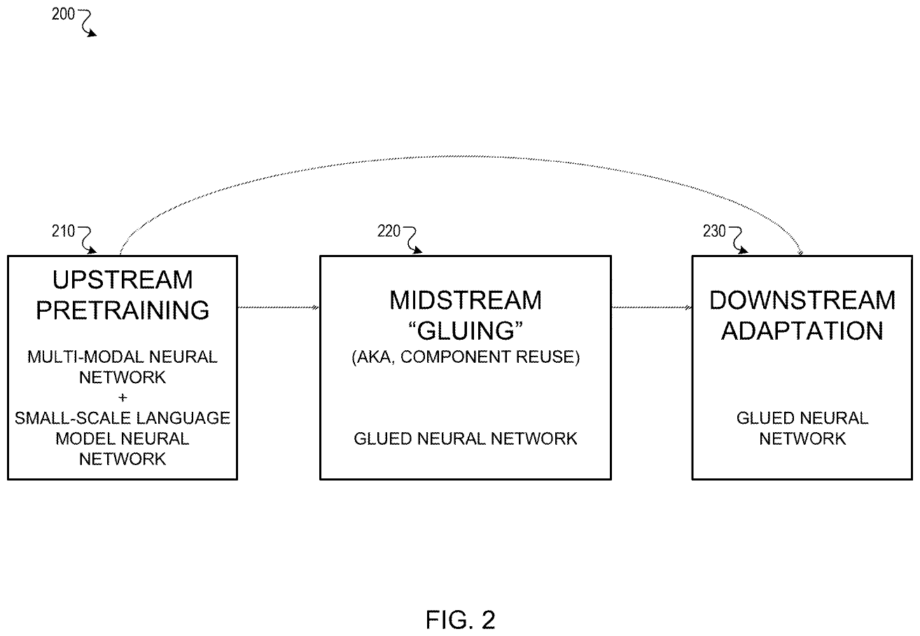

FIG. 2 is an example illustration 200 of an upstream pre-training stage 210, a midstream training stage 220, and a downstream adaptation stage 230, where at least the midstream training stage 220 can be performed by the training system 100 of FIG. 1B.

During the upstream pre-training stage 210, a multi-modal neural network is trained to perform one or more upstream multi-modal tasks. The multi-modal neural network includes a visual encoder neural network and a small-scale language model neural network. Further, a large-scale language model neural network is trained to perform one or more upstream language modeling tasks.

The midstream training stage 220 follows the upstream pre-training stage 210. During the midstream training stage 220, a glued neural network is generated based on reusing components of the multi-modal neural network and the large-scale language model neural network. For example, the glued neural network can include the visual encoder neural network and the large-scale language model neural network. The glued neural network is trained to perform one or more midstream multi-modal tasks on midstream training data.

The downstream adaptation stage 230 follows the midstream training stage 220. After having been trained to perform the midstream multi-modal task, during the downstream adaptation stage 230, the glued neural network is adapted, e.g., in a zero-shot, few-shot, or finetuning adaptation manner, to perform one or more downstream multi-modal tasks.

Optionally, the downstream adaptation stage 230 can also follow the upstream pre-training stage 210. For example, after having been trained to perform the perform the one or more upstream multi-modal tasks, the multi-modal neural network is adapted to perform one or more downstream multi-modal tasks. As another example, after having been trained to perform the perform the one or more upstream language modeling tasks, the large-scale language model neural network is adapted to perform one or more downstream multi-modal tasks.

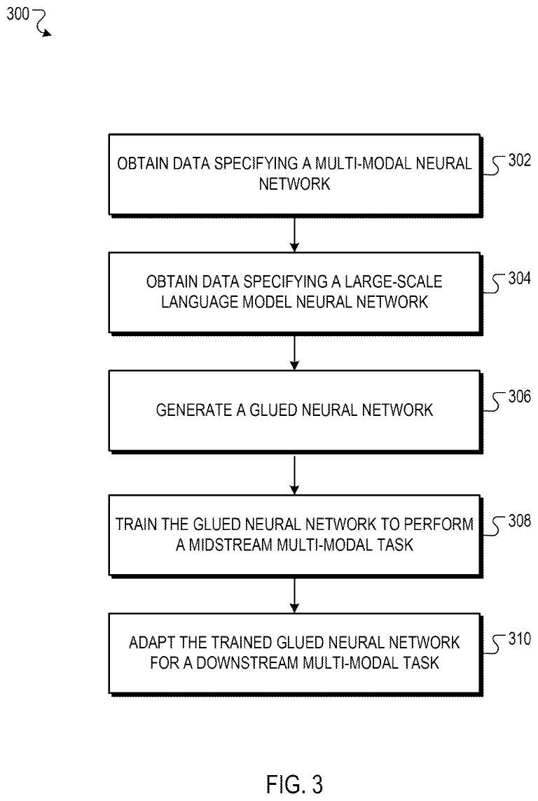

FIG. 3 is a flow diagram of an example process 300 for training a glued neural network. For convenience, the process 300 will be described as being performed by a system of one or more computers located in one or more locations. For example, a training system, e.g., the training system 100 of FIG. 1, appropriately programmed, can perform the process 300.

The system obtains data specifying a visual encoder neural network (step 302). The visual encoder neural network has been trained jointly with a small-scale language model neural network as part of a multi-modal neural network that has been trained to perform one or more upstream multi-modal tasks.

The system obtains data specifying a large-scale language model neural network (step 304). The large-scale language model neural network has been trained to perform one or more upstream language modeling tasks. Being referred to as “large-scale” means the large-scale language model neural network has a greater number of parameters, sometimes an order of magnitude greater number of parameters, than the small-scale language model neural network included in the multi-modal neural network.

The system generates a glued neural network based on the visual encoder neural network and the large-scale language model neural network (step 306). The glued neural network includes the layers and their associated parameters taken from both the visual encoder neural network and the large-scale language model neural network.

In particular, the glued neural network no longer includes the small-scale language model neural network that is included in the multi-modal neural network. Instead, the glued neural network includes at least some of the layers of the large-scale language model neural network in place of the small-scale language model neural network. In the meanwhile, the glued neural network includes at least some of the layers of the visual encoder neural network included in the multi-modal neural network.

The system trains the glued neural network to perform a midstream multi-modal task on midstream training data (step 308). The midstream training data includes a plurality of midstream training pairs. Each midstream training pair includes a visual input that includes an image and a text sequence.

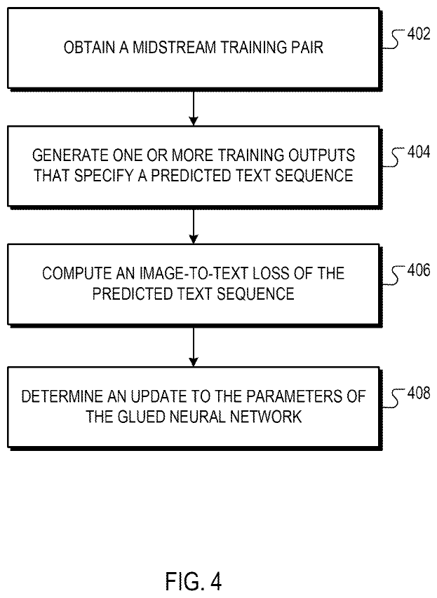

Training the glued neural network to perform the midstream multi-modal task is described in more detail below with reference to FIG. 4, which is a flow diagram of sub-steps 402-408 of step 308 of the process 300. The system can continue performing iterations of sub-steps 402-408 to train the glued neural network until termination criteria for the training of the glued neural network have been satisfied, e.g., until the parameters have converged, until a threshold amount of wall clock time has elapsed, or until a threshold number of iterations of the sub-steps 402-408 have been performed.

The system obtains a batch of midstream training pairs from the midstream training data (step 402). The system will generally obtain different midstream training pairs at different iterations, e.g., by sampling a fixed number of midstream training pairs from a larger set of midstream training pairs at each iteration.

The system processes each midstream training pair included in the batch using the glued neural network to generate one or more training outputs for the midstream training pair (step 404). The glued neural network can generally be configured to generate any kind of training outputs.

For example, the midstream multi-modal task can be an image-to-text generation task that requires the glued neural network to process, for each midstream training pair, the visual input included in the midstream training pair to generate one or more training outputs that specify a predicted text sequence that is a prediction of a corresponding text sequence included in the midstream training pair.

As another example, the midstream multi-modal task can be a text-to-image generation task that requires the glued neural network to process, for each midstream training pair, the text sequence included in the midstream training pair to generate one or more training outputs that specify a predicted visual input that is a prediction of the visual input included in the midstream training pair.

The system computes a loss function for the midstream multi-modal task that evaluates a quality of the one or more training outputs generated by the glued neural network (step 406). The loss function can be any loss function that is appropriate for the midstream multi-modal task.

In the example where the midstream multi-modal task is an image-to-text generation task, the loss function can be a self-supervised loss function that includes one or more terms that measure, for each midstream training pair included in the batch, a difference between (i) a predicted text sequence that is generated by the glued neural network based on processing the visual input included in the midstream training pair and (ii) the text sequence, the visual input, or both included in the midstream training pair.

In the example where the midstream multi-modal task is a text-to-image generation task, the loss function for the midstream multi-modal task can be a self-supervised loss function that includes one or more terms that measure, for each midstream training pair included in the batch, a difference between (i) a predicted visual output, e.g., an image, that is generated by the glued neural network based on processing the text sequence included in the midstream training pair and (ii) the visual input, the text sequence, or both included in the midstream training pair.

The system determines an update to the parameters of the glued neural network based on minimizing the loss function (step 408). That is, the system can compute gradients of the loss function with respect to some of the parameters of the glued neural network, e.g., through backpropagation, and then apply an optimizer to the gradients to update those parameters of the glued neural network.

In particular, the system adjusts the values of only a proper subset of the parameters of the glued neural network while holding the values of the parameters that are not in the proper subset fixed.

In some implementations, the proper subset of the parameters of the glued neural network includes parameters of an attentional pooling layer of the glued neural network. In some of these implementations, the attentional pooling layer is taken from the visual encoder neural network that is included in the multi-modal neural network.

That is, the system sets the initial values of the parameters of the attentional pooling layer included in the glued neural network to be the same as the trained values of the parameters of the attentional pooling layer that have been determined as a result of the training of the multi-modal neural network that has already occurred, and then continues to adjust the parameters of the attentional pooling layer included in the glued neural network over the plurality of training iterations beginning from their initial values.

In some implementations, the proper subset of the parameters of the glued neural network additionally includes parameters of one or more attention layers, parameters of one or more feed-forward layers, or a combination thereof of these and possibly other layers of the glued neural network.

That is, the system sets the initial values of the parameters of the layers of the decoder neural network included in the glued neural network to be the same as the trained values of the parameters of the layers of the large-scale language model neural network that have been determined as a result of the training of the large-scale language model neural network that has already occurred, and then continues to adjust the parameters of the layers of the decoder neural network included in the glued neural network over the plurality of training iterations beginning from their initial values.

In either implementations, because the parameters of the layers of the encoder neural network included in the glued neural network are not in the proper subset, they will be held fixed over the plurality of training iterations. That is, the system does not update the parameters of the layers of the encoder neural network, such that these parameters continue to have the trained values that have been determined as a result of the training of the multi-modal neural network that has already occurred.

After training the glued neural network to perform the midstream multi-modal task, the system adapts the trained glued neural network for a downstream multi-modal task (step 210). For example, the system can perform zero-shot, few-shot, or finetuning downstream adaptation in order to use at least part of the glued neural network for the downstream multi-modal task.

When performing finetuning adaptation, some implementations of the system can execute multiple trail runs of training to decide which portions of the parameters of the glued neural network to be adjusted (and which other portions of the parameters of the glued neural network to be held fixed to their trained values that have been determined as a result of the upstream and/or midstream training that has already occurred). This can improve the efficiency of the finetuning adaptation.

Specifically, at each of the multiple trial runs of training, the system holds different portions of the parameters of the glued neural network, e.g., parameters of different layers of the glued neural network, frozen in the trial run. The system then determines, from respective performance gains of the glued neural network over the multiple trial runs, a selected portion of the parameters of the glued neural network to be held frozen during the subsequent finetuning adaptation. For example the portions of the parameters that resulted in the greatest performance gain will be held frozen when adapting the trained glued neural network for the downstream multi-modal task.

In various implementations, the downstream multi-modal task may be different from any of the upstream multi-modal tasks (on which the multi-modal neural network has been trained) or the midstream multi-modal task. By training the glued neural network that reuses components from both a multi-modal neural network and a large-scale language model neural network, however, the system can train the glued neural network to perform better after midstream training, i.e., at downstream adaptation, than conventional training techniques because the glued neural network can leverage the knowledge learned from the upstream training and midstream training to generalize better to new downstream tasks. For example, conventional training techniques may directly attempt to adapt a pre-trained neural network to downstream tasks, i.e., without any midstream training or component reuse of two or more separately pre-trained neural networks.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
obtaining data specifying a visual encoder neural network that has been trained jointly with a small-scale language model neural network as part of a multi-modal neural network that has been trained to perform one or more upstream multi-modal tasks;
obtaining data specifying a large-scale language model neural network that has been trained to perform one or more upstream language modeling tasks;
generating a glued neural network that includes parameters taken from both the visual encoder neural network and the large-scale language model neural network;
training the glued neural network to perform a midstream multi-modal task, including adjusting learned values of only a proper subset of the parameters of the glued neural network by using a set of midstream training pairs that each include a respective visual input and a respective text sequence, while holding learned values of the parameters that are not in the proper subset fixed; and
after training the glued neural network to perform the midstream multi-modal task, adapting the trained glued neural network for a downstream multi-modal task.

2. The method of claim 1, wherein generating the glued neural network comprises:
replacing the small-scale language model neural network included in the multi-modal neural network with the large-scale language model neural network.

3. The method of claim 1, wherein the large-scale language model neural network has a greater number of parameters than the small-scale language model neural network included in the multi-modal neural network.

4. The method of claim 1, wherein adapting the trained glued neural network for the downstream multi-modal task comprises:
performing multiple trial runs of training, wherein different portions of the parameters of the glued neural network are held frozen in each trial run; and
determining, from respective performance gains of the glued neural network over the multiple trial runs, a selected portion of the parameters of the glued neural network to be held frozen when adapting the trained glued neural network for the downstream multi-modal task.

5. The method of claim 1, wherein the proper subset of the parameters of the glued neural network comprises parameters of an attentional pooling layer of the visual encoder neural network.

6. The method of claim 1, wherein the proper subset of the parameters of the glued neural network comprises parameters of one or more attention layers, parameters of one or more feed-forward layers, or a combination thereof of the large-scale language model neural network.

7. The method of claim 1, wherein the glued neural network comprises: (i) neural network layers of the visual encoder neural network followed by (ii) the attentional pooling layer followed by (iii) neural network layers of the large-scale language model neural network, wherein the glued neural network is configured to perform operations comprising:
using the attentional pooling layer to update an output of a last layer of the visual encoder neural network based at least on applying an attention mechanism;
generating, from the respective text sequence included in each midstream training pair and in accordance with a predetermined mapping, one or more text embeddings; and
providing the updated output and the one or more text embeddings to a first layer of the large-scale language model neural network.

8. The method of claim 1, wherein training the glued neural network to perform the midstream multi-modal task comprises:
obtaining a midstream training pair that includes a visual input and a text sequence;
processing the midstream training pair using the glued neural network to generate one or more training outputs that specify a predicted text sequence;
computing an image-to-text loss of the predicted text sequence relative to the visual input, the text sequence, or both included in the midstream training pair; and
determining an update to the parameters of the glued neural network based on minimizing the image-to-text loss.

9. The method of claim 8, wherein the midstream training pair includes multiple visual inputs and multiple text sequences, the multiple text sequences being interleaved within the multiple visual inputs.

10. The method of claim 8, wherein each training output specifies a respective probability distribution over a vocabulary of tokens for each position within the predicted text sequence.

11. The method of claim 1, wherein the visual encoder neural network and the small-scale language model neural network have been jointly trained to minimize both a contrastive learning loss and a captioning loss using a set of upstream training pairs that each include a respective visual input and a respective text sequence.

12. The method of claim 1, wherein the upstream language modeling tasks comprise one or more of: a text understanding task, a text generation task, or a translation task.

13. The method of claim 1, wherein adapting the trained glued neural network for the downstream multi-modal task comprises using one of:
a zero-shot learning technique, a few-shot learning technique, or a fine-tuning technique.

14. The method of claim 1, wherein the downstream multi-modal task is different from any of the upstream or midstream multi-modal tasks.

15. A system comprising one or more computers and one or more storage devices storing instructions that are operable, when executed by the one or more computers, to cause the one or more computers to perform operations comprising:
obtaining data specifying a visual encoder neural network that has been trained jointly with a small-scale language model neural network as part of a multi-modal neural network that has been trained to perform one or more upstream multi-modal tasks;
obtaining data specifying a large-scale language model neural network that has been trained to perform one or more upstream language modeling tasks;
generating a glued neural network that includes parameters taken from both the visual encoder neural network and the large-scale language model neural network;
training the glued neural network to perform a midstream multi-modal task, including adjusting learned values of only a proper subset of the parameters of the glued neural network by using a set of midstream training pairs that each include a respective visual input and a respective text sequence, while holding learned values of the parameters that are not in the proper subset fixed; and
after training the glued neural network to perform the midstream multi-modal task, adapting the trained glued neural network for a downstream multi-modal task.

16. (canceled)

17. The system of claim 15, wherein generating the glued neural network comprises:
replacing the small-scale language model neural network included in the multi-modal neural network with the large-scale language model neural network.

18. The system of claim 15, wherein the large-scale language model neural network has a greater number of parameters than the small-scale language model neural network included in the multi-modal neural network.

19. The system of claim 15, wherein adapting the trained glued neural network for the downstream multi-modal task comprises:
performing multiple trial runs of training, wherein different portions of the parameters of the glued neural network are held frozen in each trial run; and
determining, from respective performance gains of the glued neural network over the multiple trial runs, a selected portion of the parameters of the glued neural network to be held frozen when adapting the trained glued neural network for the downstream multi-modal task.

20. The system of claim 15, wherein the proper subset of the parameters of the glued neural network comprises parameters of an attentional pooling layer of the visual encoder neural network.

21. One or more non-transitory computer storage media encoded with instructions that, when executed by one or more computers, cause the one or more computers to perform operations comprising:
obtaining data specifying a visual encoder neural network that has been trained jointly with a small-scale language model neural network as part of a multi-modal neural network that has been trained to perform one or more upstream multi-modal tasks;
obtaining data specifying a large-scale language model neural network that has been trained to perform one or more upstream language modeling tasks;
generating a glued neural network that includes parameters taken from both the visual encoder neural network and the large-scale language model neural network;
training the glued neural network to perform a midstream multi-modal task, including adjusting learned values of only a proper subset of the parameters of the glued neural network by using a set of midstream training pairs that each include a respective visual input and a respective text sequence, while holding learned values of the parameters that are not in the proper subset fixed; and
after training the glued neural network to perform the midstream multi-modal task, adapting the trained glued neural network for a downstream multi-modal task.
